(19) United States
(12) Patent Application Publication
(10) Pub. No.: US 2009/0327315 A1
(43) Pub. Date: Dec. 31, 2009

(54) METHOD FOR INDEXING PHOTOS IN DIGITAL PHOTO FRAME

(75) Inventor: LI-RONG ZHANG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (SHENZHEN) CO., LTD., Shenzhen City (CN); HON HAI PRECISION INDUSTRY CO., LTD., Tu-Cheng (TW)

(21) Appl. No.: 12/248,600

(22) Filed: Oct. 9, 2008

(30) Foreign Application Priority Data
Jun. 25, 2008 (CN) 200810302313.7

(51) Int. Cl. G06F 17/30

(52) U.S. Cl. 707/100; 707/E17.009

(57) ABSTRACT

A method for indexing photos in a digital photo frame includes inputting a category to the digital photo frame, inputting information of a photo to the digital photo frame, analyzing and indexing the information of the photo according to its relationship with previously input information of other photos, and building an index diagram to display on the digital photo frame.

### BACKGROUND

1. Technical Field

The present invention relates to a method for indexing photos in a digital photo frame.

2. Description of Related Art

A typical digital photo frame may be used for conveniently browsing photos and other information. A user usually has many photos and the subject matter of the photos may include a broad range of categories and sub-categories, for example, a large number of photos may be categorized under people and have many sub-categories such as family members, friends, schoolmates, and colleagues. Sorting through all the sub-categories of people becomes difficult and inconvenient.

What is needed, therefore, is a convenient method of indexing photos in a digital photo frame.

### BRIEF DESCRIPTION OF THE DRAWINGS

FIG. 1 is a configuration diagram of an embodiment of a digital photo frame for realizing a method of indexing photos; and

FIG. 2 is a flow chart of an embodiment of a method for indexing photos in the digital photo frame.

### DETAILED DESCRIPTION

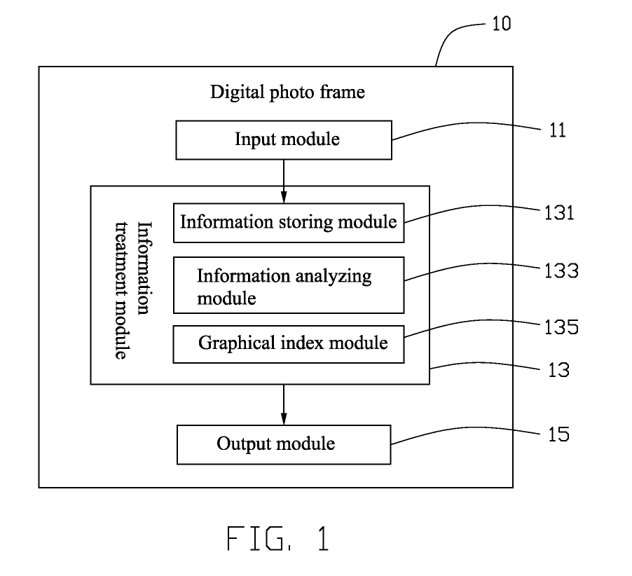

Referring to FIG. 1, a digital photo frame 10 is provided for realizing a method of indexing photos stored in the digital photo frame 10, thereby helping a user to conveniently search and browse the photos stored in the frame 10. The frame 10 includes an input module 11 for receiving information such as a category and a sub-category of a photo inputted by the user, an information treatment module 13 for analyzing and indexing the information inputted by the user and building an index diagram, and an output module 15 for displaying the diagram on the frame 10.

The information treatment module 13 includes an information storing module 131 for storing the information of a photo inputted by the user, an information analyzing module 133 for analyzing and indexing the information inputted by the user according to its relationship with previously inputted information of other photos, and associating the photo with the corresponding category, and a graphical index module 135 for building the index diagram.

In use, a user inputs one or more categories and two or more sub-categories for associating the photos stored in the frame 10, before inputting individual photo information. For example, a category input may be people. Sub-categories input for the category, people, may include family, friends, classmates, colleagues, and others. Each sub-category may have sub-categories of its own such as a sub-subcategory, my Uncle's family, in the subcategory, family. When the user inputs photo information to the frame 10, the information treatment module 13 analyzes and indexes the photo information input by the user according to its relationship with previously input information of other photos, and associate the photo with the corresponding category. When the user wants to classify a photo stored in the frame 10 according to category and subcategory, a command to call up the index diagram on the screen of the frame 10 is selected and the desired category and sub-category are selected. If the user wishes a stored photo to be indexed to more than one category or subcategory, the process may be repeated until the photo has been indexed to the desired categories and subcategories.

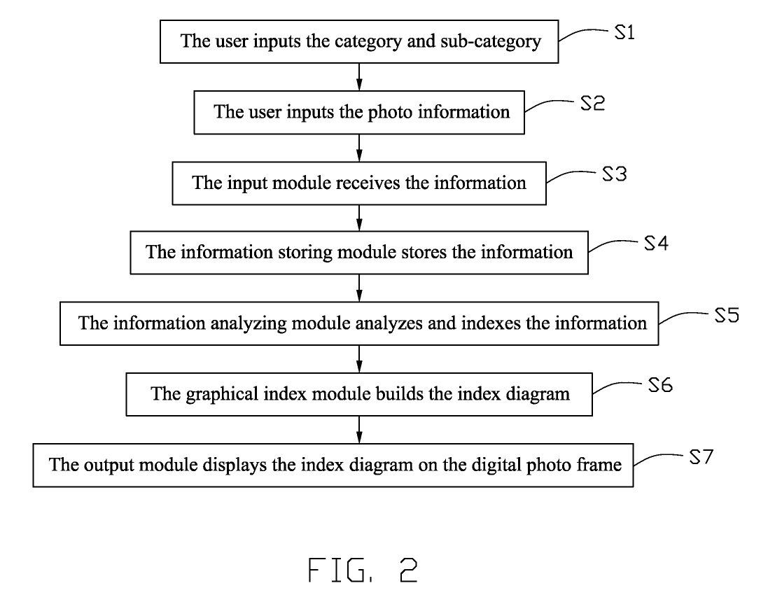

Referring to FIG. 2, a flow chart of a method for indexing photos in the digital photo frame 10 is shown. Depending on the embodiment, certain of the steps described below may be removed, others may be added, and the sequence of steps may be altered.
S1: The user inputs one or more categories and two or more sub-categories to the digital photo frame 10;
S2: The user inputs photo information to the digital photo frame 10;
S3: The input module 11 receives the information inputted by the user, and transmits the information to the information treatment module 13;
S4: The information storing module 131 of the information treatment module 13 stores the information;
S5: The information analyzing module 133 analyzes and indexes the information inputted by the user according to its relationship with previously inputted information of other photos, thereby associating photos with the corresponding category and sub-category;
S6: The graphical index module 135 builds an index diagram;
S7: The output module 15 displays the index diagram on the digital photo frame 10.

It is to be understood, however, that even though numerous characteristics and advantages of the embodiments have been set forth in the foregoing description, together with details of the structure and function of the invention, the disclosure is illustrative only, and changes may be made in detail, especially in matters of shape, size, and arrangement of parts within the principles of the embodiments to the full extent indicated by the broad general meaning of the terms in which the appended claims are expressed.

What is claimed is:

1. A method comprising:
providing a digital photo frame having a plurality of photos stored therein;
inputting a category to the digital photo frame;
inputting information of a selected photo to the digital photo frame;
analyzing and indexing the information of the selected photo according to its relationship with previously inputted information of other photos;
building an index diagram; and
displaying the index diagram on the digital photo frame.

2. The method of claim 1, wherein the category comprises a plurality of sub-categories.

3. The method of claim 1, wherein the digital photo frame comprises an input module for receiving the information inputted by the user, an information treatment module for analyzing and indexing the information and building an index diagram, and an output module for displaying the index diagram.

4. The method of claim 3, wherein the information treatment module comprises an information storing module for storing the information inputted by the user, an information analyzing module for analyzing and indexing the information inputted by the user according to its relationship with previously inputted information of other photos, and a graphical index module for building the index diagram.
